(19) United States
(12) Patent Application Publication
(10) Pub. No.: US 2026/0164002 A1
(43) Pub. Date: Jun. 11, 2026

(54) IMAGE DISPLAY METHOD AND SYSTEM, COMPUTER READABLE STORAGE MEDIUM, AND ELECTRONIC DEVICE

(71) Applicants: Beijing BOE Display Technology Co., Ltd., Beijing (CN); BOE Technology Group Co., Ltd., Beijing (CN)

(72) Inventor: Zhaoyun GU, Beijing (CN)

(73) Assignees: Beijing BOE Display Technology Co., Ltd., Beijing (CN); BOE Technology Group Co., Ltd., Beijing (CN)

(21) Appl. No.: 18/704,070

(22) PCT Filed: Apr. 28, 2022
(86) PCT No.: PCT/CN2022/090044

§ 371 Date: Apr. 24, 2024

(51) Int. Cl. H04N 13/117; G06F 3/01; G09G 5/36; H04N 13/15; H04N 13/302; H04N 13/383

(52) U.S. Cl. CPC H04N 13/117; G06F 3/013; G09G 5/36; H04N 13/15; H04N 13/302; H04N 13/383

(57) ABSTRACT

The present disclosure relates to the technical field of light field 3D image display, and relates to an image display method and system, a computer readable storage medium, and an electronic device. The method includes: obtaining one or more original viewpoint images by a first execution subject, and obtaining a first to-be displayed image by processing the original viewpoint images; sending the first to-be-displayed image to a second execution subject by the first execution subject; and controlling a display panel to display the first to-be-displayed image by the second execution subject.

### CROSS-REFERENCE TO RELATED APPLICATION

The present application is a U.S. National Stage of International Application No. PCT/CN2022/090044, filed on Apr. 28, 2022, the content of which is incorporated by reference herein in its entirety.

### TECHNICAL FIELD

Embodiments of the present disclosure relate to the technical field of image display in light field 3D, and specifically, to an image display method, an image display system, a computer-readable storage medium, and an electronic device.

### BACKGROUND

In existing image display methods, all data processing relies on the same execution subject; however, when the image display data is large, the burden on the execution subject will be heavier, resulting in lower image processing efficiency.

### SUMMARY

According to one aspect of embodiments of the present disclosure, there is provided an image display method, including:
obtaining one or more original viewpoint images by a first execution subject, and obtaining a first to-be-displayed image by processing the original viewpoint images;
sending the first to-be-displayed image to a second execution subject by the first execution subject; and
controlling a display panel to display the first to-be-displayed image by the second execution subject.

In an embodiment of the present disclosure, the first execution subject includes a processor provided in a host, and the second execution subject includes a field programmable gate array provided in a display device.

In an embodiment of the present disclosure, the first execution subject includes an IC provided in a display device, and the second execution subject includes the IC or a field programmable gate array provided in the display device.

In an embodiment of the present disclosure, obtaining the first to-be-displayed image by processing the original viewpoint images includes:
when determining that a number of viewpoints of current viewpoints included in a same pixel island meets a preset condition, obtaining a viewpoint tile image by tiling the original viewpoint images in the pixel island;
converting the viewpoint tile image from an original image architecture to a pixel island architecture, and determining a line-of-sight area of the viewpoint tile image;
calculating a second number of pixel rows of dummy pixel rows that need to be inserted in the pixel island architecture according to a first number of pixel rows that the line-of-sight area has and a clock cycle; and
obtaining target image data by inserting dummy pixel rows corresponding to the second number of pixel rows in the pixel island architecture, and obtaining the first to-be-displayed image by performing a format conversion on the target image data.

In an embodiment of the present disclosure, the method further includes:
calculating the number of viewpoints of the current viewpoints included in the same pixel island, and determining whether the number of viewpoints and the number of data time-division multiplexed channels included in the pixel island meet a first preset quantity relationship;
if the number of viewpoints and the number of channels meet the first preset quantity relationship, determining that the number of viewpoints of the current viewpoints meets the preset condition; and
if the number of viewpoints and the number of channels do not meet the first preset quantity relationship, determining that the number of viewpoints of the current viewpoints does not meet the preset condition.

In an embodiment of the present disclosure, the method further includes:
if the number of viewpoints and the number of channels do not meet the first preset quantity relationship, calculating a number of dummy viewpoints that need to be added based on the number of viewpoints and the number of channels; and
adding dummy viewpoints equal to the number of dummy viewpoints in the current viewpoints until an increased number of viewpoints and the number of channels meet the first preset quantity relationship.

In an embodiment of the present disclosure, converting the viewpoint tile image from the original image architecture to the pixel island architecture includes:
converting the viewpoint tile image from an original horizontal RGB image architecture into a vertical RGB pixel island architecture.

In an embodiment of the present disclosure, calculating the second number of pixel rows of dummy pixel rows that need to be inserted in the pixel island architecture according to the first number of pixel rows that the line-of-sight area has and the clock cycle includes:
determining whether a second preset quantity relationship is met between the first number of pixel rows that the line-of-sight area has and the clock cycle;
if the second preset quantity relationship is met, the second number of pixel rows of dummy pixel rows that need to be inserted in the pixel island architecture is zero; and
if the second preset quantity relationship is not met, calculating the second number of pixel rows of the dummy pixel rows according to the first number of pixel rows and the clock cycle.

In an embodiment of the present disclosure, determining whether the second preset quantity relationship is met between the first number of pixel rows that the line-of-sight area has and the clock cycle includes:
determining an activation mode of GOA timing of the line-of-sight area, and determining the first number of pixel rows that the line-of-sight area has and the clock cycle according to the activation mode; wherein the line-of-sight area includes a human eye gaze area and/or a human eye non-gaze area;
determining whether the second preset quantity relationship is met between the first number of pixel rows and the clock cycle; where, when the line-of-sight area is the human eye gaze area, the activation mode of the GOA timing includes a first activation mode or a second activation mode; when the line-of-sight area is the human eye non-gaze area, the activation mode of the GOA timing includes a second activation mode or a third activation mode;
where, the first activation mode is GOA row-by-row activation, the second activation mode is GOA two-row concurrent activation, and the third activation mode is GOA four-row concurrent activation.

In an embodiment of the present disclosure, obtaining the first to-be-displayed image by performing the format conversion on the target image data includes:
obtaining the first to-be-displayed image by performing format conversion on the target image data according to the activation mode of the GOA timing of the line-of-sight area;
where, when the activation mode is the first activation mode, converting the target image data into the first to-be-displayed image with a first preset data format;
when the activation mode is the second activation mode, convert the target image data into the first to-be-displayed image with a second preset data format; and
when the activation mode is the third activation mode, converting the target image data into the first to-be-displayed image with a third preset data format.

In an embodiment of the present disclosure, after obtaining the first to-be-displayed image by performing the format conversion on the target image data, the method further includes:
determining whether a first transistor type of a first thin film field effect transistor included in a source driver chip in the display panel is consistent with a second transistor type of a second thin film field effect transistor in the display panel;
if the first transistor type and the second transistor type are inconsistent, obtaining a second to-be-displayed image by performing grayscale reverse processing on the first to-be-displayed image.

In an embodiment of the present disclosure, obtaining the second to-be-displayed image by performing grayscale reverse processing on the first to-be-displayed image includes:
determining whether the source driver chip includes a floating channel;
when it is determined that the floating channel is included, inserting a dummy pixel column into the first to-be-displayed image, and obtaining the second to-be-displayed image by performing grayscale reverse processing on the first to-be-displayed image with the dummy pixel column inserted; where, an insertion position of the dummy pixel column in the first to-be-displayed image corresponds to a position of the floating channel in the source driver chip; and
when it is determined that the floating channel is not included, obtaining the second to-be-displayed image by performing grayscale reverse processing on the first to-be-displayed image.

In an embodiment of the present disclosure, the method further includes:
calculating a number of source driver chips required to drive the display panel according to a number of pixel islands included in the display panel, a number of viewpoints of current viewpoints included in each pixel island, and a lateral resolution of the display panel;
calculating a total number of channels of the display panel according to a number of chip channels of the source driver chip and the number of source driver chips, and calculating a number of floating channels that need to be inserted in the source driver chip based on the total number of channels and the lateral resolution; and
setting an insertion rule for the floating channels, so that the floating channels are inserted into corresponding source driver chips according to the insertion rule.

In an embodiment of the present disclosure, the insertion rule includes at least one of the following rules;
each source driver chip with a floating channel inserted is placed in a first preset placement manner;
the floating channel is placed in the source driver chip in a second preset placement manner; and
each source driver chip with a floating channel inserted is placed in a corresponding position of the display panel in a third preset manner.

In an embodiment of the present disclosure, the method further includes:
adding an information row to the first to-be-displayed image or the second to-be-displayed image; where the information row is configured to represent a position of a high-definition area.

According to one aspect of embodiments of the present disclosure, there is provided an image display system, including:
a first execution subject configured to obtain one or more original viewpoint images, process the original viewpoint images, and obtain a first to-be-displayed image; and send the first to-be-displayed image to a second execution subject; and
the second execution subject communicatively connected to the first execution subject and configured to control the display panel to display the first to-be-displayed image.

In an embodiment of the present disclosure, the first execution subject includes a processor provided in a host, and the second execution subject includes a field programmable gate array provided in a display device.

In an embodiment of the present disclosure, the first execution subject includes an IC provided in a display device, and the second execution subject includes the IC or a field programmable gate array provided in the display device.

In an embodiment of the present disclosure, the first execution subject may be configured to: when determining that a number of viewpoints of current viewpoints included in a same pixel island meets a preset condition, obtain a viewpoint tile image by tiling the original viewpoint images in the pixel island; convert the viewpoint tile image from an original image architecture to a pixel island architecture, and determine a line-of-sight area of the viewpoint tile image; calculate a second number of pixel rows of dummy pixel rows that need to be inserted in the pixel island architecture according to a first number of pixel rows that the line-of-sight area has and a clock cycle; and obtain target image data by inserting dummy pixel rows corresponding to the second number of pixel rows in the pixel island architecture, and obtain the first to-be-displayed image by performing a format conversion on the target image data.

In an embodiment of the present disclosure, the first execution subject may be further configured to: calculate the number of viewpoints of the current viewpoints included in the same pixel island, and determine whether the number of viewpoints and the number of data time-division multiplexed channels included in the pixel island meet a first preset quantity relationship; if the number of viewpoints and the number of channels meet the first preset quantity relationship, determine that the number of viewpoints of the current viewpoints meets the preset condition; and if the number of viewpoints and the number of channels do not meet the first preset quantity relationship, determine that the number of viewpoints of the current viewpoints does not meet the preset condition.

In an embodiment of the present disclosure, the first execution subject may be further configured to: if the number of viewpoints and the number of channels do not meet the first preset quantity relationship, calculate a number of dummy viewpoints that need to be added based on the number of viewpoints and the number of channels; and add dummy viewpoints equal to the number of dummy viewpoints in the current viewpoints until an increased number of viewpoints and the number of channels meet the first preset quantity relationship.

In an embodiment of the present disclosure, the first execution subject may be further configured to: convert the viewpoint tile image from an original horizontal RGB image architecture into a vertical RGB pixel island architecture.

In an embodiment of the present disclosure, the first execution subject may be further configured to: determine whether a second preset quantity relationship is met between the first number of pixel rows that the line-of-sight area has and the clock cycle; if the second preset quantity relationship is met, the second number of pixel rows of dummy pixel rows that need to be inserted in the pixel island architecture is zero; and if the second preset quantity relationship is not met, calculate the second number of pixel rows of the dummy pixel rows according to the first number of pixel rows and the clock cycle.

In an embodiment of the present disclosure, the first execution subject may be further configured to: determine an activation mode of GOA timing of the line-of-sight area, and determining the first number of pixel rows that the line-of-sight area has and the clock cycle according to the activation mode; where the line-of-sight area includes a human eye gaze area and/or a human eye non-gaze area; determine whether the second preset quantity relationship is met between the first number of pixel rows and the clock cycle; where, when the line-of-sight area is the human eye gaze area, the activation mode of the GOA timing includes a first activation mode or a second activation mode; when the line-of-sight area is the human eye non-gaze area, the activation mode of the GOA timing includes a second activation mode or a third activation mode; where, the first activation mode is GOA row-by-row activation, the second activation mode is GOA two-row concurrent activation, and the third activation mode is GOA four-row concurrent activation.

In an embodiment of the present disclosure, the first execution subject may be further configured to: obtain the first to-be-displayed image by performing format conversion on the target image data according to the activation mode of the GOA timing of the line-of-sight area; where, when the activation mode is the first activation mode, converting the target image data into the first to-be-displayed image with a first preset data format; when the activation mode is the second activation mode, convert the target image data into the first to-be-displayed image with a second preset data format; and when the activation mode is the third activation mode, converting the target image data into the first to-be-displayed image with a third preset data format.

In an embodiment of the present disclosure, the first execution subject may be further configured to: determine whether a first transistor type of a first thin film field effect transistor included in a source driver chip in the display panel is consistent with a second transistor type of a second thin film field effect transistor in the display panel; if the first transistor type and the second transistor type are inconsistent, obtain a second to-be-displayed image by performing grayscale reverse processing on the first to-be-displayed image.

In an embodiment of the present disclosure, the first execution subject may be further configured to: determine whether the source driver chip includes a floating channel; when it is determined that the floating channel is included, insert a dummy pixel column into the first to-be-displayed image, and obtain the second to-be-displayed image by performing grayscale reverse processing on the first to-be-displayed image with the dummy pixel column inserted; where, an insertion position of the dummy pixel column in the first to-be-displayed image corresponds to a position of the floating channel in the source driver chip; and when it is determined that the floating channel is not included, obtain the second to-be-displayed image by performing grayscale reverse processing on the first to-be-displayed image.

In an embodiment of the present disclosure, the first execution subject may be further configured to: calculate a number of source driver chips required to drive the display panel according to a number of pixel islands included in the display panel, a number of viewpoints of current viewpoints included in each pixel island, and a lateral resolution of the display panel; calculate a total number of channels of the display panel according to a number of chip channels of the source driver chip and the number of source driver chips, and calculate a number of floating channels that need to be inserted in the source driver chip based on the total number of channels and the lateral resolution; and set an insertion rule for the floating channels, so that the floating channels are inserted into corresponding source driver chips according to the insertion rule.

In an embodiment of the present disclosure, the insertion rule includes at least one of the following rules;
each source driver chip with a floating channel inserted is placed in a first preset placement manner;
the floating channel is placed in the source driver chip in a second preset placement manner; and
each source driver chip with a floating channel inserted is placed in a corresponding position of the display panel in a third preset manner.

In an embodiment of the present disclosure, the first execution subject may be further configured to: add an information row to the first to-be-displayed image or the second to-be-displayed image; where the information row is configured to represent a position of a high-definition area.

According to one aspect of the embodiments of the present disclosure, there is provided a computer-readable storage medium on which a computer program is stored, wherein when the computer program is executed by a processor, the image display method as described in any one of the above embodiments.

According to one aspect of the embodiments of the present disclosure, there is provided an electronic device, including:
a processor; and
a memory for storing executable instructions for the processor;
where, the processor is configured to execute the image display method as described in any one of the embodiments by executing the executable instructions.

It should be understood that the above general description and the detailed description that follows are exemplary and explanatory only and do not limit the present disclosure.

### BRIEF DESCRIPTION OF THE DRAWINGS

The accompanying drawings, which are incorporated in and constitute a part of this specification, illustrate embodiments consistent with the disclosure and together with the description, serve to explain the principles of the disclosure. Obviously, the drawings in the following description are only some embodiments of the present disclosure. For those of ordinary skill in the art, other drawings can be obtained based on these drawings without exerting creative efforts. In the accompany drawings:

FIG. 1 schematically shows a flowchart of an image display method according to an embodiment of the present disclosure.

FIG. 2 schematically shows a block diagram of an image display system according to an embodiment of the present disclosure.

FIG. 3 schematically shows an example diagram of original viewpoint images according to an embodiment of the present disclosure.

FIG. 4 schematically shows an example diagram of original viewpoint images with a dummy viewpoint added according to an embodiment of the present disclosure.

FIG. 5 schematically shows an example diagram of a vertical RGB pixel island architecture according to an embodiment of the present disclosure.

FIG. 6 schematically shows an example diagram of a second number of pixel rows of inserted dummy pixel rows for a different GOA timing partition according to an embodiment of the present disclosure.

FIG. 7 schematically shows an example diagram of a pixel island architecture after inserting Dummy row data (dummy pixel rows) according to an embodiment of the present disclosure.

FIG. 8 schematically shows an example diagram of a first to-be-displayed image with a first preset data format (RRRRGGGGBBBB) according to an embodiment of the present disclosure.

FIG. 9 schematically shows a flowchart of a method for processing a first to-be-displayed image to obtain a second to-be-displayed image according to an embodiment of the present disclosure.

FIG. 10 schematically shows an example diagram of placing a source driver chip with a floating channel inserted to one side of a display panel according to an embodiment of the present disclosure.

FIG. 11 schematically shows an example diagram of placing a source driver chip with a floating channel inserted to the left and right sides of a display panel according to an embodiment of the present disclosure.

FIG. 12 schematically shows a specific example diagram of assigning a floating channel to a dummy pixel column according to an embodiment of the present disclosure.

FIG. 13 schematically shows a flowchart of another image display method according to an embodiment of the present disclosure.

FIG. 14 schematically shows a block diagram of an image display device according to an embodiment of the present disclosure.

FIG. 15 schematically shows an electronic device for implementing the above image display method according to an embodiment of the present disclosure.

### DETAILED DESCRIPTION

Example embodiments will now be described more fully with reference to the accompanying drawings. Example embodiments may, however, be embodied in various forms and should not be construed as limited to the examples set forth herein; rather, these embodiments are provided so that the present disclosure will be thorough and complete, and will fully convey the concepts of the example embodiments to those skilled in the art. The described features, structures or characteristics may be combined in any suitable manner in one or more embodiments.

Furthermore, the drawings are merely schematic illustrations of the present disclosure and are not necessarily drawn to scale. The same reference numerals in the drawings represent the same or similar parts, and thus their repeated description will be omitted. Some of the block diagrams shown in the figures are functional entities and do not necessarily correspond to physically or logically separate entities. These functional entities may be implemented in software form, or implemented in one or more hardware modules or integrated circuits, or implemented in different networks and/or processor devices and/or microcontroller devices.

The resolutions of existing display panels are all standard resolutions, such as FHD (Full High Definition) display panels, 4K display panels, and 8K display panels, etc. Before the display panel is controlled by the FPGA to display the image, it is also necessary to perform processing such as GOA timing and Data mapping on the image to be displayed through FPGA.

However, the above solution has the following shortcomings: on the one hand, it does not involve how to process image data with non-standard resolutions; on the other hand, FPGA programming, especially debugging, takes too long, and the complex GOA timing and Data mapping for light field projects take more time, which affects the product output time, that is, the image processing efficiency is low.

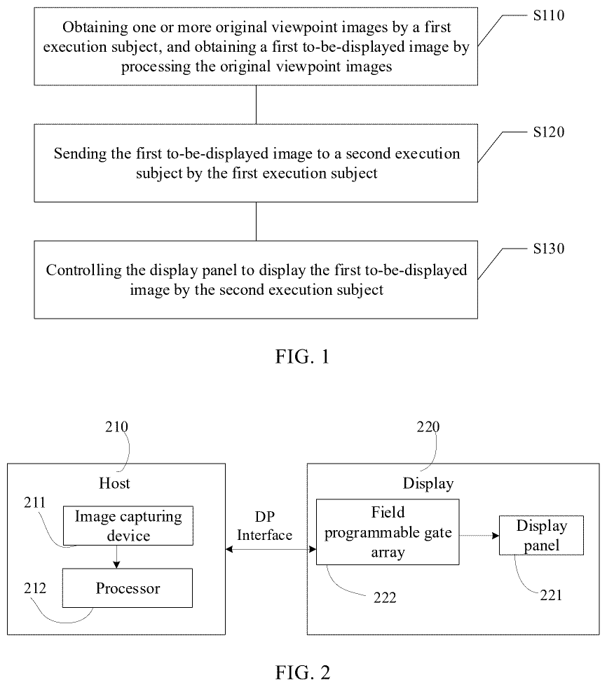

Based on this, the embodiment first provides an image display method, which can be run on a host, a display device, a server, a server cluster, a cloud server, etc. Of course, those skilled in the art can also run the method of the present disclosure on other platforms according to needs, which is not particularly limited by the embodiment. Referring to FIG. 1, the image display method may include the following steps:

Step S110, obtaining one or more original viewpoint images by a first execution subject, and obtaining a first to-be-displayed image by processing the original viewpoint images.

In the embodiment, firstly, obtain one or more original viewpoint images, and when determining that the number of viewpoints of the current viewpoints included in a same pixel island meets a preset condition, tile the original viewpoint images in the pixel island to obtain a viewpoint tile image. Secondly, convert the viewpoint tile image from the original image architecture to the pixel island architecture, and determine the line-of-sight area of the viewpoint tile image. Then, according to the first number of pixel rows that the line-of-sight area has and the clock cycle, calculate the second number of pixel rows of dummy pixel rows that need to be inserted in the pixel island architecture. Further, insert dummy pixel rows corresponding to the second number of pixel rows in the pixel island architecture, and obtain target image data, and perform format conversion on the target image data to obtain a first to-be-displayed image.

Specifically, the second number of pixel rows of dummy pixel rows that need to be inserted in the pixel island architecture can be calculated based on the first number of pixel rows that the line-of-sight area has and the clock cycle. Finally, the dummy pixel rows corresponding to the second number of pixel rows are inserted in the pixel island architecture to obtain target image data. The format of the target image data is converted to obtain a first to-be-displayed image. In the process of displaying the first to-be-displayed image by controlling the display panel via FPGA, after the previous line-of-sight area is displayed, the pixel rows corresponding to the next line-of-sight area can be directly entered, thereby improving the smoothness of image display.

Step S120, sending the first to-be-displayed image to a second execution subject by the first execution subject.

Step S130, controlling the display panel to display the first to-be-displayed image by the second execution subject.

In the above image display method, since the processing task of the original viewpoint image and the display task of controlling the display of the first to-be-displayed image can be placed on different execution subjects, the task burden on the first execution subject and the second execution subject can be reduced, thereby improving image processing efficiency.

Below, the image display method according to the embodiments of the present disclosure will be explained and described in detail with reference to the accompanying drawings.

First, the terms involved in the embodiments of the present disclosure will be explained:
FPGA: the full name is Field-Programmable Gate Array;
TCON: Timing Control, logic control board;
X-Zone: it can be used to indicate that in a smart viewing scenario, the display panel is divided into a human eye gaze area and a human eye non-gaze area. The screen resolutions or pixel frame rates of the human eye gaze area and the human eye non-gaze area are different.

Next, the inventive purpose of the embodiments of the present disclosure is explained and described. Specifically, in some light field 3D projects, a pixel island architecture needs to be used for setup; in specific applications, the sub-pixel size and panel size determine the number of pixel islands that can be included in the display panel, resulting in the horizontal resolutions of the display panel are mostly non-standard resolutions. In order to solve the problem in the prior art that images with non-standard resolutions cannot be processed, the present disclosure proposes an image display method that can perform corresponding processing in hardware and software, thereby solving the problem of non-standard resolution.

Meanwhile, light field 3D related projects have complex GOA (Gatedriver On Array) timing. Data Mapping and huge data processing requirements. Currently, there is no available TCON solution to meet the needs. Therefore, FPGA can be used as an alternative. The programmable characteristics of FPGA make the device uniquely flexible. However, too many requirements will also take up a lot of programming and debugging time, thereby making the image display efficiency lower. In order to solve this problem, the embodiment of the present disclosure proposes performing the image display by the host, which can greatly save FPGA programming and debugging time and speed up product output. Moreover, the image display method proposed in the present disclosure can include a variety of timing and sequencing rules for display patterns: GOA row-by-row activation, GOA two-row concurrent activation, GOA four-row concurrent activation, and X-Zone, which can meet a variety of application scenarios.

In the following, the image display system involved in the embodiments of the present disclosure will be explained and described. Specifically, as shown in FIG. 2, the display system may include a host 210 and a display 220, where the host 210 and the display 220 may be connected for communication through a preset data interface. Specifically, a first execution subject may be provided in the host, and a first execution subject and/or a second execution subject may be provided in the display device. The first execution subject includes a processor provided in the host, and the second execution subject includes a field programmable gate array provided in the display device. Meanwhile, the first execution subject may also include an IC provided in the display device, and the second execution subject includes the IC or a field programmable gate array provided in the display device. Further, when the first execution subject is an IC provided in the display device, the IC can simultaneously perform the task of image processing (processing the original viewpoint images to obtain the first to-be-displayed image) and the task of controlling the first to-be-displayed image. Image processing and image display can be implemented in the IC at the same time.

In an embodiment, when the first execution subject is a processor provided in the host and the second execution subject is a field programmable gate array provided in the display device, the image display system can perform the image processing task and the image display task in the following manner. Specifically, the display 220 may include a display panel 221 and a field programmable gate array 222. The host is connected to the field programmable gate array through a preset data interface. The field programmable gate array is configured to receive the first to-be-displayed image or the second to-be-displayed image sent by the host through the preset data interface, and to control the display panel to display the first to-be-displayed image or the second to-be-displayed image. The preset data interface can be Display Port (DP), and of course it can also be other interfaces that can transmit videos or images, which is not particularly limited by this example. Meanwhile, the host 210 may include an image capture device 211 and a processor (such as CPU and/or GPU) 212. The image capture device may be configured to capture the human eye image of the current user, and the processor may be configured to determine the human eye gaze area and the human eye non-gaze area of the current user on the display panel based on the captured human eye image. The processor can further be configured to perform the image processing task recorded in the embodiments of the present disclosure.

In an embodiment provided by the present disclosure, in the process of processing the original viewpoint images, firstly, the viewpoint image tiling process needs to be performed. Specifically, it can be implemented in the following manner: when determining that the number of viewpoints of the current viewpoints included in a same pixel island meets a preset condition, the original viewpoint images in the pixel island are tiled to obtain a viewpoint tile image.

Specifically, firstly, the original viewpoint images are obtained, where the original viewpoint images are pictures corresponding to each current viewpoint (View). The system does not perform any processing on the original viewpoint image. Each current viewpoint can correspond to one original viewpoint image. For example, the original viewpoint images can be shown in FIG. 3. In FIG. 3, there are 11 original viewpoint images, and the corresponding current viewpoints can be, for example, View 1, View 2, and View 3, . . . , and View 11.

Secondly, after obtaining the original viewpoint images, it is necessary to determine whether the number of viewpoints of the current viewpoints included in a same pixel island meets a preset condition. The specific judgment process of whether the preset condition is met can be realized in the following way. Firstly, calculate the number of viewpoints of the current viewpoints included in the same pixel island, and determine whether a first preset quantity relationship is met between the number of viewpoints and the number of channels for data time-division multiplexing included in the pixel island. Secondly, if the first preset quantity relationship is met between the number of viewpoints and the number of channels, it is determined that the number of viewpoints of the current viewpoints meets the preset condition. Further, if the first preset quantity relationship is not met between the number of viewpoints and the number of channels, it is determined that the number of viewpoints of the current viewpoints does not meet the preset condition. Furthermore, if the first preset quantity relationship is not met between the number of viewpoints and the number of channels, the number of dummy viewpoints that need to be added is calculated based on the number of viewpoints and the number of channels; and then dummy viewpoints equal to the number of dummy viewpoints are added in the current viewpoints until the increased number of viewpoints and the number of channels meet the first preset quantity relationship.

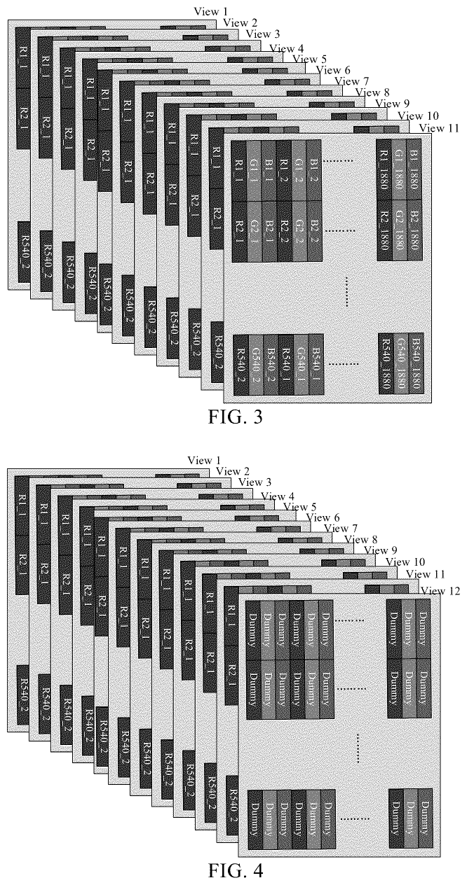

For example, firstly, determine whether the number of current viewpoints (Views) contained in a same pixel island is an integer multiple of the number of MUX (multiplexer, data time-division multiplexing) channels. If it is not an integer multiple, as shown in FIG. 3, Dummy Views (dummy viewpoints) need to be added, so that the sum of the number of viewpoints of the current viewpoints and the number of viewpoints of the dummy viewpoints included in the pixel island is an integer multiple of the number of MUX channels. For example, the number of MUX channels included in a certain pixel island is 6, and the number of viewpoints of the current viewpoints included in the pixel island is 11, then it is confirmed that one dummy viewpoint needs to be added to the pixel island. For example, the original viewpoint images with the dummy viewpoint added can be shown in FIG. 4. In FIG. 4, there are 12 original viewpoint images, and the corresponding current viewpoints may be View 1, View 2, View 3, . . . , View 11, and View 12, for example. What needs to be added here is that the number of MUX channels included in the pixel island can be set according to actual needs, which is not particularly limited by this example. Meanwhile, in the process of adding the dummy viewpoint, the number of viewpoints of the dummy viewpoints that needs to be added can be calculated based on the difference between the number of viewpoints of the current viewpoints and a certain integer multiple of the number of MUX channels. Through this method, it can be ensured that the display content included in the same pixel island is the same during 2D display, thereby further improving the accuracy of image display; and, by setting the number of viewpoints set in the same pixel island to an integer multiple of the number of MUX channels, it allows the current viewpoints and/or dummy viewpoints to be evenly distributed to each MUX switch when controlling the current viewpoints and/or dummy viewpoints included in the pixel island through the MUX switches, which can achieve the purpose of load balancing.

What needs further explanation here is that the pixel information included in the dummy viewpoint may be irrelevant or relevant to the information included in View 1, View 2, View 3, . . . , and View 11, which is not particularly limited by this example. Moreover, since the added dummy viewpoint is only used in the process of processing the original viewpoint images to obtain the first to-be-displayed image, the newly added dummy viewpoint is not displayed. Therefore, no matter whether the pixel information in the dummy viewpoint is relevant to View 1, View 2, View 3, . . . , and View 11, it will not affect the final display result, thereby achieving accurate display of the image.

Further, when determining that the number of viewpoints of the current viewpoints included in the same pixel island meets the preset condition, the original viewpoint images in the pixel island can be tiled to obtain a viewpoint tile image. In the process of tiling the original viewpoint images and/or the dummy viewpoint images, the tiling can be performed sequentially according to the viewpoint coding of the dummy viewpoint and/or the current viewpoint corresponding to the original viewpoint image and/or the dummy viewpoint image, or tiling can also be performed in other ways, which is not particularly limited by this example.

In an embodiment provided by the present disclosure, in the process of processing the original viewpoint image, secondly, image architecture conversion processing also needs to be performed. Specifically, this can be achieved in the following manner: convert the viewpoint tile image from the original image architecture into a pixel island architecture, and determine the line-of-sight area of the viewpoint tile image.

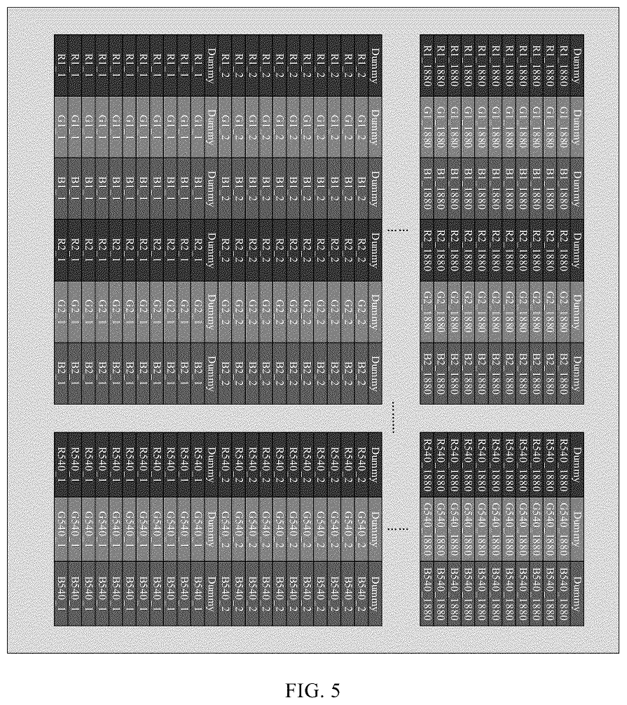

Specifically, in the process of architecture conversion, it can be achieved in the following manner: converting the viewpoint tile image from the original horizontal RGB image architecture to the vertical RGB pixel island architecture; where, the obtained vertical RGB pixel island architecture can be shown in FIG. 5.

In an embodiment provided by the present disclosure, during the process of processing the original viewpoint image, it is further necessary to calculate the dummy pixel rows that need to be inserted. Specifically, it can be implemented in the following manner: calculating the second number of pixel rows of dummy pixel rows that need to be inserted in the pixel island architecture according to the first number of pixel rows that the line-of-sight area has and the clock cycle.

In the embodiment, firstly, it is determined whether a second preset quantity relationship is met between the first number of pixel rows that the line-of-sight area has and the clock cycle; secondly, if the second preset quantity relationship is met, then the second number of pixel rows of the dummy pixel rows that need to be inserted in the pixel island architecture is zero; then, if the second preset quantity relationship is not met, the second number of pixel rows of the dummy pixel rows is calculated according to the first number of pixel rows and the clock cycle.

In the specific process of determining whether the second preset number relationship between the first number of pixel rows that the line-of-sight area has and the clock cycle is met, the process can be performed in the following manner: firstly, determining the activation mode of the GOA timing in the line-of-sight area, and determining the first number of pixel rows that the line-of-sight area has and the clock cycle according to the activation mode, where the line-of-sight area includes a human eye gaze area and/or a human eye non-gaze area; secondly, determining whether a second preset quantity relationship is met between the first number of pixel rows and the clock cycle. When the line-of-sight area is the human eye gaze area, the activation mode of the GOA timing includes a first activation mode or a second activation mode. When the line-of-sight area is a human eye non-gaze area, the activation mode of the GOA timing includes a second activation mode or a third activation mode. The first activation mode is GOA row-by-row activation, the second activation mode is GOA two-row concurrent activation, and the third activation mode is GOA four-row concurrent activation.

Specifically, in a smart viewing scenario, the display panel needs to be divided into a human eye gaze area and a human eye non-gaze area. The screen resolutions or pixel frame rates for the human eye gaze area and the human eye non-gaze area are different. That is, the human eye gaze area needs to have a higher screen resolution and pixel frame rate, and the human eye non-gaze area can have a lower screen resolution and pixel frame rate. Therefore, the X-Zone design will divide the display panel into several partitions, and determine whether the number of CLK activations in each partition is an integer multiple of the CLK cycle (clock cycle). If it is not an integer multiple, in order to facilitate CLK connection between partitions, dummy row data (dummy pixel row) needs to be inserted to make it to be an integer multiple. If it is an integer multiple, the dummy pixel rows that need to be inserted are zero, that is, there is no need to insert dummy pixel rows. It should be added here that the number of CLK activation in this partition is consistent with the first number of pixel rows in this partition. That is, when CLK is activated once, it controls one pixel row for display. Therefore, in specific application process, it can also be implemented by determining whether of the first number of pixel rows in the partition is an integral multiple of the CLK cycle.

Furthermore, the timings of different GOAs are different at certain nodes. The second numbers of pixel rows of dummy pixel rows that need to be inserted in different partitions are different. The data formats that need to be output are also different. Therefore, taking a display panel with 1620 rows in the vertical direction of the entire screen, 6 partitions (the sum of the human eye gaze area and the human eye non-gaze area is 6, where the proportion of the human eye gaze area and the human eye non-gaze area can be set according to actual needs during the application process, which is not particularly limited in this example) and 270 row per partition as an example, the specific calculation method for the second number of pixel rows of dummy pixel rows that need to be inserted in each partition is as follows for example.

On the one hand, for the human eye gaze area in GOA row-by-row activation: the CLK cycle is 24, CLK is activated 270 times for each partition, and 270 is not divisible by 24. The number of dummy pixel rows that need to be inserted for each partition=([270/24]+1)*24−270=18 rows, and there are 288 rows in total for each partition.

On the other hand, for the human eye gaze area and/or human eye non-gaze area in GOA two-row concurrent activation: the CLK cycle is 12, CLK is activated 135 times for each partition, and 135 is not divisible by 24. The number of dummy rows that need to be inserted for each partition=([135/12]+1)*12−135=9 rows, and there are 144 rows in total for each partition.

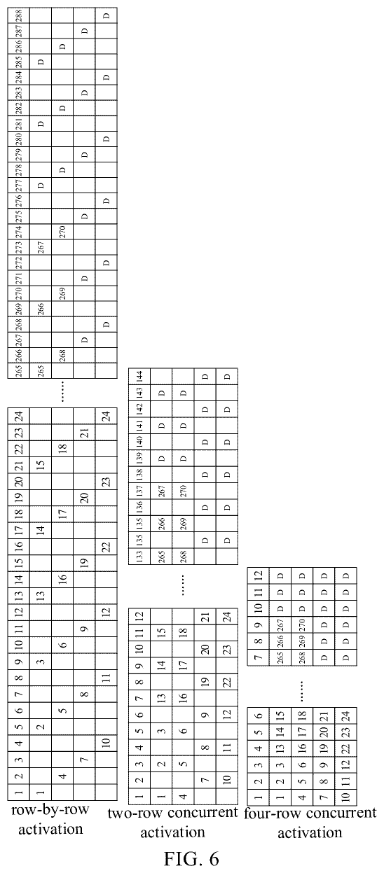

On the other hand, for the human non-gaze area in GOA four-row concurrent activation: the CLK cycle is 6, CLK is activated 69 times for each partition, and 69 is not divisible by 6. The number of dummy rows that need to be inserted for each partition=([69/6]+1)*6−69=3 rows, and there are 72 rows in total for each partition. The second number of pixel rows of dummy pixel rows inserted into different GOA timing partitions can be specifically referred to as shown in FIG. 6.

It needs to be added here that, by setting the second number of pixel rows included in the human eye gaze area and/or the human eye non-gaze area to an integer multiple of the clock cycle, all pixel rows included in the area in the current clock cycle are activated, which avoids the problem of not being able to perform a smooth display due to the fact that too many second number of pixel rows cannot be fully activated or too few second number of pixel rows needs to occupy the second number of pixel rows in the next area during the clock cycle in this area. It is realized that in the process of controlling the display panel through the FPGA to display the first to-be-displayed image, when the display of the previous line-of-sight area is completed, it is possible to go directly to the pixel rows corresponding to the next line-of-sight area, thereby improving the smoothness of image display. It needs to be further explained here that, the determination of the human eye gaze area and/or the human eye non-gaze area can be achieved in the following manner: capturing the human eye image of the current user through an image capturing device; determining the position and azimuth angle of the current user's eyes relative to the display panel based on the captured human eye image of the current user; determining the human eye gaze area of the user on the display panel based on the position and azimuth angle; and determining the area other than the human eye gaze area on the display panel as the human eye non-gaze area.

In an embodiment provided by the present disclosure, in the process of processing the original viewpoint image, finally, image data format conversion also needs to be performed. Specifically, it can be implemented in the following manner: obtaining target image data by inserting dummy pixel rows corresponding to the second number of pixel rows in the pixel island architecture; and obtaining a first to-be-displayed image by performing format conversion on the target image data.

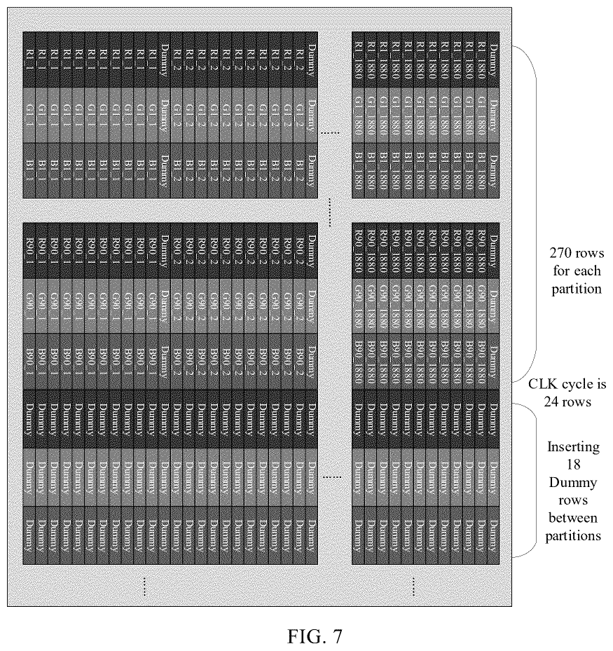

In this embodiment, firstly, dummy pixel rows corresponding to the second number of pixel rows are inserted into the pixel island architecture, and then the target image data can be obtained. The obtained target image data can be specifically shown in FIG. 7. Secondly, after obtaining the target image data, it is also necessary to perform format conversion on the target data to obtain the first to-be-displayed image. The data format conversion can be achieved in the following ways: performing format conversion on the target image data according to the activation mode of the GOA timing of the line-of-sight area, to obtain the first to-be-displayed image. When the activation mode is a first activation mode, the target image data is converted into a first to-be-displayed image with a first preset data format. When the activation mode is a second activation mode, the target image data is converted into a first to-be-displayed image with a second preset data format. When the activation mode is a third activation mode, the target image data is converted into a first to-be-displayed image with a third preset data format.

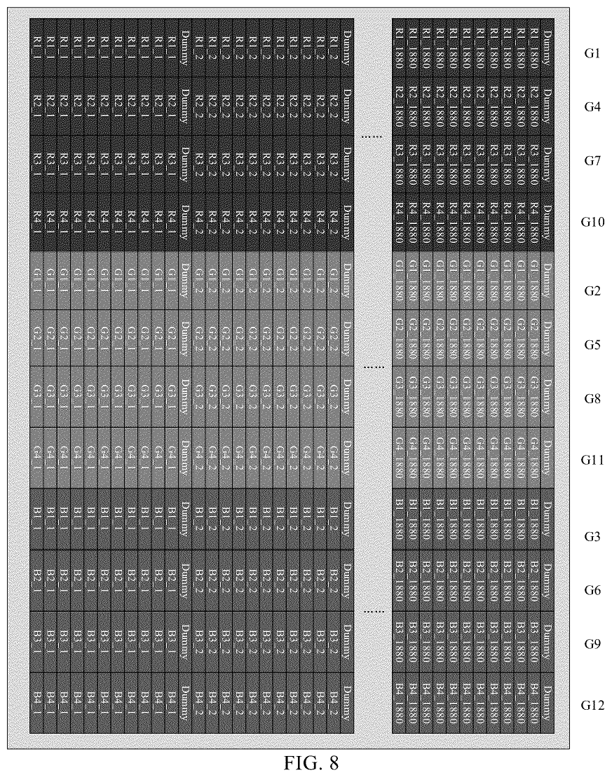

Specifically, first of all, due to GOA design, the gate activating sequence is row 1 (R)→row 4 (R)→row 7 (R)→row 10 (R)→row 2 (G)→row 5 (G)→Row 8 (G)→Row 11 (G)→Row 3 (B)→Row 6 (B)→Row 9 (B)→Row 12 (B) . . . , and the data transmission during GOA row-by-row activation should be converted to 4R4G4B (RRRRGGGGBBBB). That is, the first to-be-displayed image with the first preset data format can be 4R4G4B, for example, as shown in FIG. 8. Secondly, the two rows of Gate are turned on at the same time and only one set of the same data is given. Therefore, in the case of GOA two-row concurrent activation, it needs to be output in the RRGGBB (i.e., 2R2G2B) mode, which is one-half the amount of data in row-by-row activation. Furthermore, the four rows of gates are activated at the same time, and only one set of the same data is given. Therefore, in the case of GOA four-row concurrent activation, it needs to be output in RGB mode, which is one-quarter the amount of data in row-by-row activation. Meanwhile, for X-zones, for example, row-by-row activation for high-definition area and four-row concurrent activation for low-definition area, each high-definition area outputs data in a 4R4G4B mode, and each low-definition area outputs data in a RGB mode. In some cases, when considering whether to use 2R2G2B mode for output in the high-definition area or low-definition area, it can be determined by the charging speed of the corresponding area of the display panel. If the charging speed is fast, the 2R2G2B mode output can be selected in the low-definition area; and if the charging speed is slow; the 2R2G2B mode output can be selected in the high-definition area, which is not particularly limited by this example.

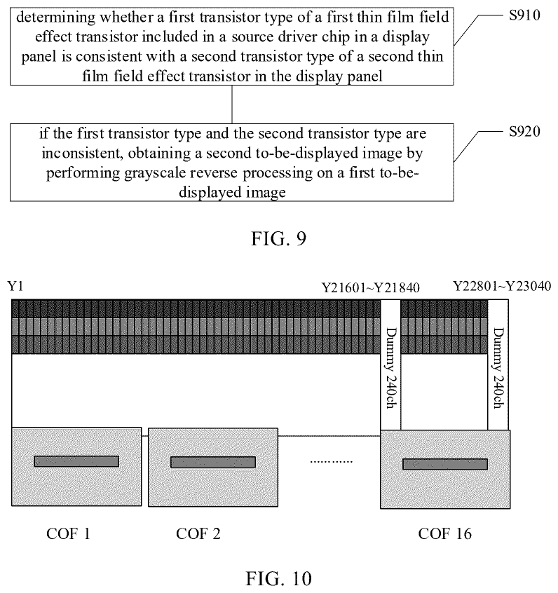

FIG. 9 schematically shows a flowchart of a method for obtaining a second to-be-displayed image by processing a first to-be-displayed image according to an embodiment of the present disclosure. Specifically, as shown in FIG. 9, it may include the following steps:
step S910, determining whether a first transistor type of a first thin film field effect transistor included in a source driver chip in a display panel is consistent with a second transistor type of a second thin film field effect transistor in the display panel; and
step S920: if the first transistor type and the second transistor type are inconsistent, obtaining a second to-be-displayed image by performing grayscale reverse processing on a first to-be-displayed image.

Obtaining the second to-be-displayed image by performing grayscale reverse processing on the first to-be-displayed image can be implemented in the following manner: firstly, determining whether the source driver chip includes a floating channel; secondly, in response to determining that the source driver chip includes the floating channel, inserting a dummy pixel column into the first to-be-displayed image, and obtaining the second to-be-displayed image by performing grayscale reverse processing on the first to-be-displayed image after inserting the dummy pixel column. The insertion position of the dummy pixel column in the first to-be-displayed image corresponds to the position of the floating channel in the source driver chip. Further, in response to determining that the floating channel is not included, obtaining the second to-be-displayed image by performing grayscale reverse processing on the first to-be-displayed image. The insertion rules include at least one of the following rules: each source driver chip with a floating channel inserted is placed in a first preset placement manner; the floating channel is placed in the source driver chip in a second preset placement manner; each source driver chip with a floating channel inserted is placed in the corresponding position of the display panel in a third preset manner.

In the following, steps S910 to S920 will be explained and described. First, whether the first transistor type of the first thin film field effect transistor TFT included in the Source Driver IC (source driver chip) is consistent with the second transistor type of the second thin film field effect transistor TFT used in the display panel is determined. If They are not of the same type (inconsistent), for example, the Source Driver IC is suitable for NMOS, and the gray scale is proportional to the voltage, while the Panel is PMOS TFT, and the gray scale is inversely proportional to the voltage, then it requires grayscale reverse processing of the picture. The specific processing of the grayscale reverse is: the grayscale in the picture (the first to-be-displayed image)=L255 grayscale−the grayscale that needs to be displayed. If L0 needs to be displayed, the grayscale of the picture needs to be L255. That is, the grayscale value of the first to-be-displayed image can be displayed by the grayscale value obtained from the L255 grayscale−the grayscale that needs to be displayed. The specific calculation formula can be shown as the following formula (1):

$$L layout diagram = L255 - L display ; \qquad formula ( 1 )$$

Furthermore, during actual application, it is also necessary to insert a dummy pixel column into the first to-be-displayed image. Specifically, the insertion rules of dummy pixel columns can be as follows: firstly, determining whether the Source IC (source driver chip) has a floating channel (floating channel). If so, it needs to give the floating channel dummy data, so it needs to insert the dummy column data (dummy pixel column) into the picture, where the insertion position of the dummy column data corresponds to the floating channel. If there is no floating channel, grayscale processing can be performed directly. It needs to be added here that, the specific judgment process of transistor type and the specific judgment process of floating channel are not strictly limited in the actual implementation process. The corresponding processing flow can be set according to actual needs, which is not particularly limited by this example.

Furthermore, in order to assign a dummy pixel column to a floating channel, the floating channel need to be set in the source driver chip. Specifically, the pixel island architecture is designed to meet both the pixel size and the display panel size, and the resolution is mostly non-standard. For example, there are 12 views for each pixel island, and there are 1880 pixel islands in total, and the horizontal resolution is 1880*12/3=7520*RGB. Assuming that the number of channels in a COF is 1440, the required number of COFs=7520*3/1440=15.67˜16. Therefore, when specifically designing floating channels in a COF, the following design rules can be followed.

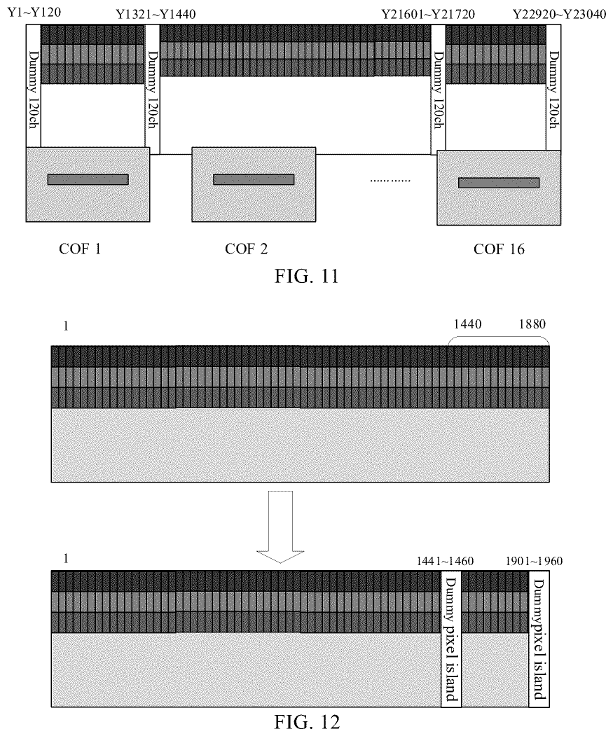

The total number of channels in 16 COFs=16*1440=23040, 23040=7520*RGB=480, that is, the number of channels in the Source IC is 480 more than the actual required channels. Therefore, the hardware design can set these 480 channels to floating. The floating channel is not connected to the panel. There are three principles for floating: on the one hand, the position of each source driver chip with the floating channel inserted must be left-right symmetrical; on the other hand, in order to ensure the normal operation of the source driver chip, the floating channel needs to be fixed at both ends of the source driver chip; on the other hand, each source driver chip with the floating channel inserted needs to be placed at the far left or/and right of the display panel to minimize the interference with other Source ICs which might resulting in poor image quality. The specific placement diagrams can refer to FIG. 10 and FIG. 11. When the source driver chip COF is provided with some floating channels, the number of channels included in the source driver chip will be different from the number of channels in other source driver chips that do not have floating channels, and it is difficult to synchronize with other COFs during data processing. Therefore, when designing the FPGA or TCON included in the display device, it is necessary to design according to the standard resolution, and just give the floating channel to the dummy pixel column. For the specific implementation of giving the floating channel to the dummy pixel column, please refer to FIG. 12. Through this method, it can solve the problem of non-standard resolution that cannot be solved in the prior art.

At this point, the specific image display process of the original viewpoint image in the host computer has been completed. Further, in order to display the processed image on the display panel, the following steps need to be performed: firstly, adding an information row to the first to-be-displayed image or the second to-be-displayed image, where the information row is to characterize the position of the high-definition area; then, based on the preset data interface, sending the first to-be-displayed image or the second to-be-displayed image to the field-programmable gate array in the display, so that the field-programmable gate array drives the display panel in the display to display the first to-be-displayed image or the second to-be-displayed image. That is to say, during the specific processing process, it can be determined whether it is X-Zone timing (that is, whether it is an intelligent viewing scene). If it is X-Zone timing, since the GOA timings of the high-definition area and the low-definition area are different, the position of the high-definition area needs to be passed to the FPGA through the picture information row in order to call the appropriate timing. Therefore, a row can be added to the first row of the first to-be-displayed image or the second to-be-displayed image as an information row to facilitate the FPGA to control the display panel to perform high-definition display (displayed in RRRRGGGGBBBB, or RRGGBB) based on this information row in the process of driving the display panel for display. If timings for the entire screen are the same, there is no need to add an information row.

It needs to be added here that, the reason why the first to-be-displayed image or the second to-be-displayed image is mentioned here is that a situation exists where: when there is no floating channel and the first transistor type of the first thin film field effect transistor TFT included the Source Driver IC (source driver chip) is consistent with the second transistor type of the second thin film field effect transistor TFT used in the display panel, the first to-be-displayed image can be directly sent to the FPGA, or the first to-be-displayed image is sent to the FPGA after adding an information row; of course, when there is a floating channel, or the first transistor type of the first thin film field effect transistor TFT included in the Source Driver IC (source driver chip) is inconsistent with the second transistor type of the second thin film field effect transistor TFT used in the display panel, a dummy pixel column can be added to the first to-be-displayed image and/or grayscale reverse processing can be performed to obtain a second to-be-displayed image, and then the second to-be-displayed image is sent to the FPGA or the second to-be-displayed image is sent to the FPGA after adding an information row. Of course, when sending the first to-be-displayed image or the second to-be-displayed image to the FPGA, only the first to-be-displayed image or the second to-be-displayed image is sent each time, and the first to-be-displayed image and the second to-be-displayed image are not sent at the same time.

Further, in the process of the FPGA controlling the display panel to display the first to-be-displayed image or the second to-be-displayed image, it can be implemented in the following manner: determining a first scanning sequence for each first pixel located in the human eye gaze area when each pixel row in the display panel in the human eye gaze area is sequentially scanned; determining, based on the pixel island to which each first pixel belongs and the first scanning sequence, a first turn-on sequence of the first switch for controlling each first pixel; turning on the first switch in each pixel island sequentially according to the first turn-on sequence; and/or determining a second scanning sequence for each second pixel located in the human eye non-gaze area when all pixel rows in the pixel group are scanned at the same time for each pixel group located in the human eye non-gaze area in the display panel in sequence; determining, based on the pixel island to which each second pixel belongs and the second scanning sequence, a second turn-on sequence of the second switch for controlling each second pixel; turning on the second switch in each pixel island sequentially according to the second turn-on sequence.

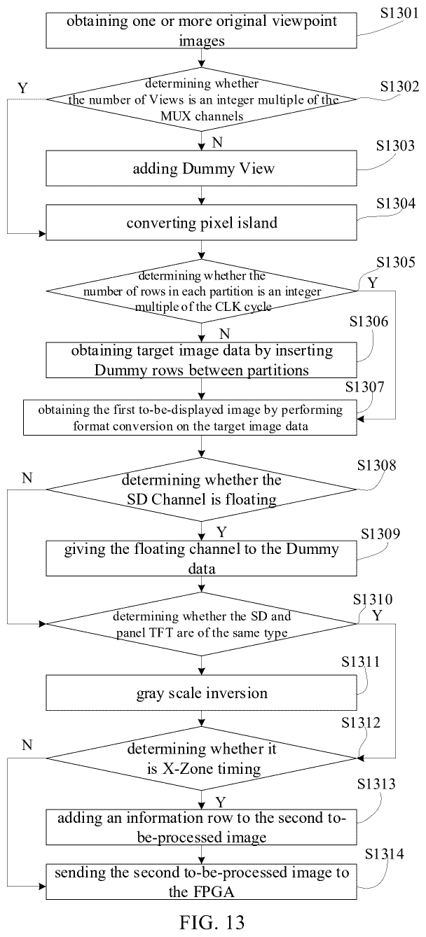

Hereinafter, the image display method recorded in the embodiment of the present disclosure will be further explained and described with reference to FIG. 13. Specifically, as shown in FIG. 13, the image display method may include the following steps:
Step S1301, obtaining one or more original viewpoint images;
Step S1302, determining whether the number of Views is an integer multiple of the MUX channels: that is, determining whether the number of viewpoints of the current viewpoints included in the same pixel island is an integer multiple of the number of MUX channels; if so, going to step S1303, if not, going to step S1304;
Step S1303, adding Dummy View: that is, calculating the number of dummy viewpoints that need to be added based on the number of viewpoints and the number of channels; adding dummy viewpoints equal to the number of dummy viewpoints in the current viewpoint until the increased number of viewpoints equals the number of channels meet the first preset quantity relationship;
Step S1304, converting pixel island: that is, obtaining a viewpoint tile image by tiling the original viewpoint images, and converting the viewpoint tile image from horizontal RGB to column RGB;
Step S1305, determining whether the number of rows in each partition is an integer multiple of the CLK cycle: that is, determining whether the first number of pixel rows in the partition is an integer multiple of the CLK cycle; if not, going to step S1306; if so, going to step S1307;
Step S1306, obtaining target image data by inserting Dummy rows between partitions: that is, for the human eye gaze area in GOA row-by-row activation: the CLK cycle is 24, and CLK is activated 270 times for each partition, and 270 is not divisible by 24, the number of Dummy rows of dummy pixel rows that need to be inserted for each partition=([270/24]+1)*24−270=18 rows, and there are 288 rows in total for each partition; for the human eye gaze area and/or human eye non-gaze area in GOA two-row concurrent activation: CLK cycle is 12, CLK is activated 135 times for each partition, and 135 is not divisible by 24, the number of Dummy rows that need to be inserted for each partition=([135/12]+1)*12−135=9 rows, and there are 144 rows in total for each partition; for the human eye non-gaze area in GOA four-row concurrent activation: CLK cycle is 6, CLK is activated 69 times for each partition, and 69 is not divisible by 6, the number of Dummy rows that need to be inserted for each partition=([69/6]+1)*6−69=3 rows, and there are 72 rows in total for each partition;
Step S1307, obtaining the first to-be-displayed image by performing format conversion on the target image data: that is, the data transmission during GOA row-by-row activation should be converted to 4R4G4B (RRRRGGGGBBBB); in the case of GOA two-row concurrent activation, it needs to be output in RRGGBB or 2R2G2B mode, which is one-half the amount of data in row-by-row activation: in the case of GOA four-row concurrent activation, it needs to be output in RGB mode, which is one-quarter of the amount of data in row-by-row activation;
Step S1308, determining whether the SD Channel is floating: that is, determining whether the Source IC (source driver chip) has a floating channel; if so, going to step S1309; if not, going to step S1310;
Step S1309, giving the floating channel to the Dummy data: that is, inserting the Dummy column data (dummy pixel column) into the first to-be-displayed image, and giving the floating channel to the Dummy column data, and the insertion position of the Dummy column data corresponds to the floating channel;
Step S1310, determining whether the SD and panel TFT are of the same type: that is, determining whether the first transistor type of the first thin film field effect transistor TFT included in the Source Driver IC (source driver chip) is consistent with the second transistor type of the second thin film field effect transistor TFT used in the display panel; if not, going to step S1311; if not, going to step S1312;
Step S1311, gray scale inversion: that is, obtaining the second to-be-processed image by performing gray scale inversion on the first to-be-displayed image with dummy column data added;
Step S1312, determining whether it is X-Zone timing; if so, going to step S1313; if not, going to step S1314;
Step S1313: adding an information row to the second to-be-processed image;
Step S1314: sending the second to-be-processed image to the FPGA.

At this point, it can be concluded without any doubt that, the image display method recorded in the embodiments of the present disclosure, on the one hand, adopts a software and hardware design that can solve the problem of non-standard resolution of the pixel island architecture; on the other hand, the image display method recorded in the embodiments of the present disclosure designs a scheme where the pixel island processes data through layout diagram; on the other hand, the image display method recorded in the embodiments of the present disclosure designs different layout rules for different GOA timings. The different layout rules for different GOA timings can be shown in Table 1 below:

TABLE 1
Different layout rules for different GOA timings

| | GOA | GOA two-row | GOA four-row | |
|---|---|---|---|---|
| | row-by-row | concurrent | concurrent | |
| Layout rule | activation | activation | activation | X-Zone |
| Adding Dummy View | ✓ | ✓ | ✓ | ✓ |
| Pixel island conversion | ✓ | ✓ | ✓ | ✓ |
| Inserting dummy rows | Inserting 18 | Inserting 9 | Inserting 3 | Inserting 18 |
| between partitions | Dummy rows; | Dummy rows; | Dummy rows; | Dummy rows in |
| | there are 288 | there are 144 | there are 72 | high-definition |
| | rows for each | rows for each | rows for each | area; inserting 3 |
| | partition | partition | partition | Dummy rows in |
| | | | | low-definition |
| | | | | area |
| 4R4G4B/2R2G2B/RGB | 4R4G4B | 2R2G2B | RGB | High-definition |
| | | | | area 4R4G4B or |
| | | | | 2R2G2B; |
| | | | | Low-definition |
| | | | | area 2R2G2B or |
| | | | | RGB |
| Floating channel | ✓ | ✓ | ✓ | ✓ |
| inserting dummy | | | | |
| column data | | | | |
| Grayscale inversion | ✓ | ✓ | ✓ | ✓ |
| Considering | — | — | — | ✓ |
| information row | | | | |
| Final image resolution | 7680*1728 | 7680*864 | 7680*432 | 7680*864 |

The following are device embodiments of the present disclosure, which can be configured to perform method embodiments of the present disclosure. For details not disclosed in the device embodiments of the disclosure, please refer to the method embodiments of the disclosure.

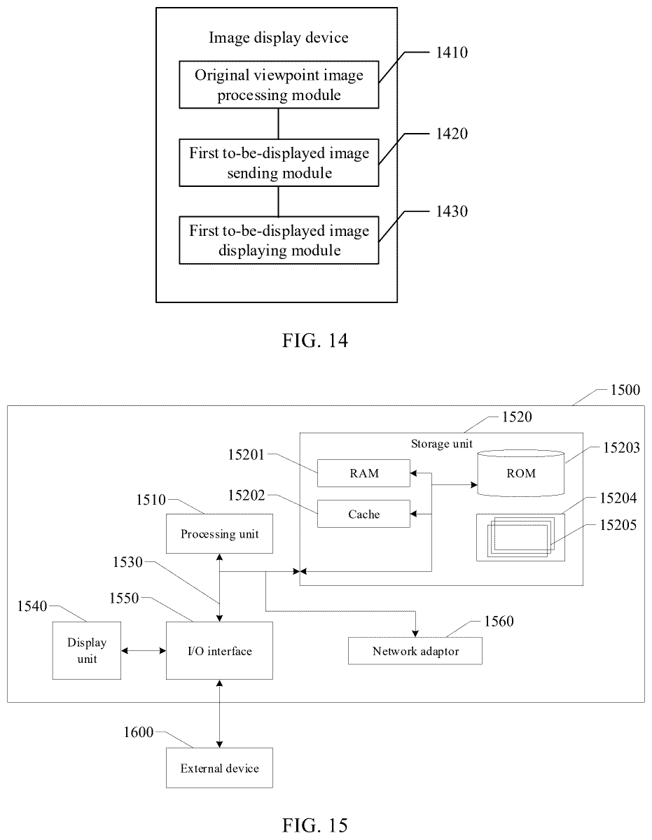

According to an aspect of the present disclosure, an image display device is provided, configured on a host. Referring to FIG. 14, the image display device may include an original viewpoint image processing module 1410, a first to-be-displayed image sending module 1420, and a first to-be-displayed image displaying module 1430.

The original viewpoint image processing module 1410 may be configured to obtain one or more original viewpoint images by a first execution subject, and obtain a first to-be-displayed image by processing the original viewpoint images.

The first to-be-displayed image sending module 1420 may be configured to send the first to-be-displayed image to a second execution subject by the first execution subject.

The first to-be-displayed image displaying module 1430 may be configured to display the first to-be-displayed image by the second execution body controlling the display panel.

In an embodiment of the present disclosure, the first execution body includes a processor provided in the host, and the second execution body includes a field programmable gate array provided in the display device.

In an embodiment of the present disclosure, the first execution body includes an IC provided in the display device, and the second execution body includes the IC or a field programmable gate array provided in the display device.

In an embodiment of the present disclosure, obtaining the first to-be-displayed image by processing the original viewpoint images includes:
when it is determined that the number of viewpoints of the current viewpoints included in the same pixel island meets a preset condition, obtaining a viewpoint tile image by tiling the original viewpoint images in the pixel island;
converting the viewpoint tile image from the original image architecture to the pixel island architecture, and determining the line-of-sight area of the viewpoint tile image;
calculating a second number of pixel rows of dummy pixel rows that need to be inserted in the pixel island architecture according to a first number of pixel rows that the line-of-sight area has and the clock cycle; and
obtaining target image data by inserting dummy pixel rows corresponding to the second number of pixel rows in the pixel island architecture, and obtaining the first to-be-displayed image by performing format conversion on the target image data.

In an embodiment of the present disclosure, the image display device further includes:
a first judging module configured to calculate the number of viewpoints of the current viewpoints included in the same pixel island, and determine whether the number of viewpoints and the number of data time-division multiplexed channels included in the pixel island meet a first preset quantity relationship;
a first determining module configured to determine that the number of viewpoints of the current viewpoints meets the preset condition if the number of viewpoints and the number of channels meet the first preset quantitative relationship; and
a second determining module configured to determine that the number of viewpoints of the current viewpoints does not meet the preset condition if the number of viewpoints and the number of channels do not meet the first preset quantitative relationship.

In an embodiment of the present disclosure, the image display device further includes:
a dummy viewpoint number calculating module configured to calculate the number of dummy viewpoints that need to be added based on the number of viewpoints and the number of channels if the number of viewpoints and the number of channels do not meet the first preset quantity relationship; and
a dummy viewpoint adding module configured to add dummy viewpoints equal to the number of dummy viewpoints in the current viewpoint until the increased number of viewpoints and the number of channels meet the first preset quantity relationship.

In an embodiment of the present disclosure, converting the viewpoint tile image from the original image architecture to the pixel island architecture includes:
converting the viewpoint tile image from the original horizontal RGB image architecture into a vertical RGB pixel island architecture.

In an embodiment of the present disclosure, calculating the second number of pixel rows of dummy pixel rows that need to be inserted in the pixel island architecture according to the first number of pixel rows that the line-of-sight area has and the clock cycle, includes:
determining whether the first number of pixel rows that the line-of-sight area has and the clock cycle meet a second preset quantity relationship;
if the second preset quantity relationship is met, the second number of pixel rows of the dummy pixel rows that need to be inserted in the pixel island architecture is zero;
if the second preset quantity relationship is not met, the second number of pixel rows of the dummy pixel rows is calculated according to the first number of pixel rows and the clock cycle.

In an embodiment of the present disclosure, determining whether a second preset quantity relationship is met between the first number of pixel rows that the line-of-sight area has and the clock cycle includes:
determining the activation mode of the GOA timing of the line-of-sight area, and determining the first number of pixel rows that the line-of-sight area has and clock cycle according to the activation mode; where the line-of-sight area includes the human eye gaze area and/or the human eye non-gaze area;
determining whether a second preset quantity relationship is met between the first number of pixel rows and the clock cycle; when the line-of-sight area is the human eye gaze area, the activation mode of the GOA timing includes a first activation mode or a second activation mode; when the line-of-sight area is a human eye non-gaze area, the activation mode of the GOA timing includes a second activation mode or a third activation mode.

In an embodiment of the present disclosure, the first activation mode is to GOA row-by-row activation, the second activation mode is GOA two-row concurrent activation, and the third activation mode is GOA four-row concurrent activation.

In an embodiment of the present disclosure, obtaining the first to-be-displayed image by performing format conversion on the target image data includes:
obtaining the first to-be-displayed image by performing format conversion on the target image data according to the activation mode of the GOA timing of the line-of-sight area;
where, when the activation mode is the first activation mode, converting the target image data into a first to-be-displayed image with a first preset data format;
when the activation mode is the second activation mode, converting the target image data into a first to-be-displayed image with a second preset data format; and
when the activation mode is the third activation mode, converting the target image data into a first to-be-displayed image with a third preset data format.

In an embodiment of the present disclosure, the image display device further includes:
a second determining module configured to determine whether the first transistor type of the first thin film field effect transistor included in the source driver chip in the display panel is consistent with the second transistor type of the second thin film field effect transistor in the display panel;
a grayscale reverse processing module configured to obtain a second to-be-displayed image by performing grayscale reverse processing on the first to-be-displayed image if the first transistor type and the second transistor type are inconsistent.

In an embodiment of the present disclosure, obtaining the second to-be-displayed image by performing grayscale reverse processing on the first to-be-displayed image includes:
determining whether the source driver chip includes a floating channel;
when it is determined that the floating channel is included, inserting a dummy pixel column into the first to-be-displayed image, and obtaining the second to-be-displayed image by performing grayscale reverse processing on the first to-be-displayed image with the dummy pixel column inserted; where, the insertion position of the dummy pixel column in the first to-be-displayed image corresponds to the position of the floating channel in the source driver chip; and
when it is determined that the floating channel is not included, obtaining the second to-be-displayed image by performing grayscale reverse processing on the first to-be-displayed image.

In an embodiment of the present disclosure, the insertion rules include at least one of the following rules:
each source driver chip with a floating channel inserted is placed in a first preset placement manner;
the floating channel is placed in the source driver chip in a second preset placement manner;
each source driver chip with a floating channel inserted is placed in the corresponding position of the display panel in a third preset manner.

In an embodiment of the present disclosure, the image display device further includes:
an information row adding module configured to add an information row in the first to-be-displayed image or the second to-be-displayed image; where the information row is configured to represent the position of the high-definition area.

The specific details of each module in the above image display device have been described in detail in the corresponding image display method, so they will not be repeated here.

It should be noted that although several modules or units of device for action execution are mentioned in the above detailed description, but such division is not mandatory. In fact, according to embodiments of the present disclosure, the features and functions of two or more modules or units described above may be embodied in one module or unit. Conversely, the feature and function of one module or unit described above may be further divided into being embodied by multiple modules or units.

Furthermore, although various steps of the methods of the present disclosure are depicted in the drawings in a specific order, this does not require or imply that the steps must be performed in that specific order, or that all of the illustrated steps must be performed to achieve the desired results. Additionally, or alternatively, certain steps may be omitted, multiple steps may be combined into one step for execution, and/or one step may be decomposed into multiple steps for execution, etc.

In an embodiment of the present disclosure, an electronic device capable of implementing the above method is also provided.

Those skilled in the art will understand that various aspects of the present disclosure may be implemented as systems, methods, or program products. Therefore, various aspects of the present disclosure may be embodied in the following forms, namely: a complete hardware implementation, a complete software implementation (including firmware, microcode, etc.), or an implementation combining hardware and software aspects, which may be collectively referred to herein as “circuits”, “modules” or “systems”.

An electronic device 1500 according to the embodiment of the present disclosure is described below with reference to FIG. 15. The electronic device 1500 shown in FIG. 15 is only an example and should not bring any limitations to the functions and usage scope of the embodiments of the present disclosure.

As shown in FIG. 15, the electronic device 1500 is embodied in the form of a general computing device. The components of the electronic device 1500 may include, but are not limited to: the above-mentioned at least one processing unit 1510, the above-mentioned at least one storage unit 1520, a bus 1530 connecting different system components (including the storage unit 1520 and the processing unit 1510), and the display unit 1540.

The storage unit stores program code, and the program code can be executed by the processing unit 1510, so that the processing unit 1510 performs steps of various exemplary embodiments according to the present disclosure described in the “Example Method” section of this specification. For example, the processing unit 1510 can perform step S110 shown in FIG. 1: obtaining one or more original viewpoint images by a first execution subject, and obtaining the first to-be-displayed image by processing the original viewpoint images; step S120: sending the first to-be-displayed image to a second execution subject by the first execution subject; step S130: controlling the display panel to display the first to-be-displayed image by the second execution subject.

The storage unit 1520 may include a readable medium in the form of a volatile storage unit, such as a random-access storage unit (RAM) 15201 and/or a cache storage unit 15202, and may further include a read-only storage unit (ROM) 15203.

The storage unit 1520 may also include a program/utility 15204 having a set of (at least one) program modules 15205 including, but not limited to: an operating system, one or more application programs, other program modules, and program data. Each of these examples, or some combination, may include the implementation of a network environment.

The bus 1530 may be one or more of several types of bus structures, including a memory unit bus or memory unit controller, a peripheral bus, a graphics acceleration port, a processing unit, or a local area bus using any of a variety of bus structures.

The electronic device 1500 may also communicate with one or more external devices 1600 (e.g., keyboard, pointing device, Bluetooth device, etc.), may also communicate with one or more devices that enable a user to interact with the electronic device 1500, and/or communicate with any device (e.g., router, modem, etc.) that enables the electronic device 1500 to communicate with one or more other computing devices. Such communication may be performed through input/output (I/O) interface 1550. Furthermore, the electronic device 1500 may also communicate with one or more networks (e.g., a local area network (LAN), a wide area network (WAN), and/or a public network, such as the Internet) through the network adapter 1560. As shown, the network adapter 1560 communicates with other modules of the electronic device 1500 via bus 1530. It should be understood that, although not shown in the figures, other hardware and/or software modules may be used in conjunction with electronic device 1500, including but not limited to: microcode, device drivers, redundant processing units, external disk drive arrays, RAID systems, tape drives and data backup storage system, etc.

Through the above description of the embodiments, those skilled in the art can easily understand that the example embodiments described here can be implemented by software, or can be implemented by software combined with necessary hardware. Therefore, the technical solution according to the embodiment of the present disclosure can be embodied in the form of a software product, which can be stored in a non-volatile storage medium (which can be a CD-ROM, U disk, mobile hard disk, etc.) or on the network, including several instructions to cause a computing device (which may be a personal computer, a server, a terminal device, a network device, etc.) to execute a method according to an embodiment of the present disclosure.

In an embodiment of the present disclosure, a computer-readable storage medium is also provided, on which a program product capable of implementing the method described above in this specification is stored. In some possible implementations, various aspects of the present disclosure can also be implemented in the form of a program product, which includes program code. When the program product is run on a terminal device, the program code is used to cause the terminal device to perform the steps according to various exemplary embodiments of the present disclosure described in the above “Example Method” section of this specification.

The program product for implementing the above method according to an embodiment of the present disclosure may adopt a portable compact disk read-only memory (CD-ROM) and include program code, and may be run on a terminal device, such as a personal computer. However, the program product of the present disclosure is not limited thereto. In this document, a readable storage medium may be any tangible medium containing or storing a program that may be used by or in conjunction with an instruction execution system, apparatus, or device.

The program product may take the form of any combination of one or more readable media. The readable medium may be a readable signal medium or a readable storage medium. The readable storage medium may be, for example, but not limited to, an electrical, magnetic, optical, electromagnetic, infrared, or semiconductor system, device or component, or any combination thereof. More specific examples (non-exhaustive list) of readable storage media include: electrical connection with one or more conductors, portable disk, hard disk, random access memory (RAM), read only memory (ROM), erasable programmable read-only memory (EPROM or flash memory), optical fiber, portable compact disk read-only memory (CD-ROM), optical storage device, magnetic storage device, or any suitable combination of the above.

A computer-readable signal medium may include a data signal propagated in baseband or as part of a carrier wave carrying readable program code therein. Such propagated data signals may take many forms, including but not limited to electromagnetic signals, optical signals, or any suitable combination of the above. A readable signal medium may also be any readable medium other than a readable storage medium that can send, propagate, or transport the program for use by or in connection with an instruction execution system, apparatus, or device.

Program code embodied on a readable medium may be transmitted using any appropriate medium, including but not limited to wireless, wireline, optical cable, RF, etc., or any suitable combination of the foregoing.

Program code for performing operations of the present disclosure may be written in any combination of one or more programming languages, including object-oriented programming languages such as Java, C++, etc., as well as conventional procedural Programming language-such as “C” or a similar programming language. The program code may be executed entirely on the user computing device, partly on the user device, as a stand-alone software package, partly on the user computing device and partly on a remote computing device, or entirely on the remote computing device or server. In situations involving the remote computing device, the remote computing device may be connected to the user computing device through any kind of network, including a local area network (LAN) or a wide area network (WAN), or may be connected to an external computing device, such as via Internet connection by the internet service provider.

In addition, the above-mentioned figures are only schematic illustrations of processes included in the methods according to the exemplary embodiments of the present disclosure, and are not intended to be limiting. It is readily understood that the processes shown in the above figures do not indicate or limit the temporal sequence of these processes. In addition, it is also easy to understand that these processes may be executed synchronously or asynchronously in multiple modules, for example.

Other embodiments of the disclosure will be readily apparent to those skilled in the art from consideration of the specification and practice of the disclosure herein. This application is intended to cover any variations, uses, or adaptations of the disclosure that follow the general principles of the disclosure and include common knowledge or customary technical means in the technical field not disclosed by the disclosure. It is intended that the specification and embodiments be considered as exemplary only, with a true scope and spirit of the disclosure being indicated by the following claims.

1. An image display method, comprising:
obtaining one or more original viewpoint images by a first execution subject, and obtaining a first to-be-displayed image by processing the original viewpoint images;
sending the first to-be-displayed image to a second execution subject by the first execution subject; and
controlling a display panel to display the first to-be-displayed image by the second execution subject.

2. The method according to claim 1, wherein the first execution subject comprises a processor provided in a host, and the second execution subject comprises a field programmable gate array provided in a display device.

3. The method according to claim 1, wherein the first execution subject comprises an IC provided in a display device, and the second execution subject comprises the IC or a field programmable gate array provided in the display device.

4. The method according to claim 1, wherein obtaining the first to-be-displayed image by processing the original viewpoint images comprises:
in response to determining that a number of viewpoints of current viewpoints comprised in a same pixel island meets a preset condition, obtaining a viewpoint tile image by tiling the original viewpoint images in the pixel island;
converting the viewpoint tile image from an original image architecture to a pixel island architecture, and determining a line-of-sight area of the viewpoint tile image;
calculating a second number of pixel rows of dummy pixel rows that need to be inserted in the pixel island architecture according to a first number of pixel rows that the line-of-sight area has and a clock cycle; and
obtaining target image data by inserting dummy pixel rows corresponding to the second number of pixel rows in the pixel island architecture, and obtaining the first to-be-displayed image by performing a format conversion on the target image data.

5. The method according to claim 4, further comprising:
calculating the number of viewpoints of the current viewpoints comprised in the same pixel island, and determining whether the number of viewpoints and the number of data time-division multiplexed channels comprised in the pixel island meet a first preset quantity relationship;
in response to the number of viewpoints and the number of channels meeting the first preset quantity relationship, determining that the number of viewpoints of the current viewpoints meets the preset condition; and
in response to the number of viewpoints and the number of channels not meeting the first preset quantity relationship, determining that the number of viewpoints of the current viewpoints does not meet the preset condition.

6. The method according to claim 5, further comprising:
in response to the number of viewpoints and the number of channels not meeting the first preset quantity relationship, calculating a number of dummy viewpoints that need to be added based on the number of viewpoints and the number of channels; and
adding dummy viewpoints equal to the number of dummy viewpoints in the current viewpoints until an increased number of viewpoints and the number of channels meet the first preset quantity relationship.

7. The method according to claim 4, wherein converting the viewpoint tile image from the original image architecture to the pixel island architecture comprises:
converting the viewpoint tile image from an original horizontal RGB image architecture into a vertical RGB pixel island architecture.

8. The method according to claim 4, wherein calculating the second number of pixel rows of dummy pixel rows that need to be inserted in the pixel island architecture according to the first number of pixel rows that the line-of-sight area has and the clock cycle comprises:
determining whether a second preset quantity relationship is met between the first number of pixel rows that the line-of-sight area has and the clock cycle;
in response to meeting the second preset quantity relationship, the second number of pixel rows of dummy pixel rows that need to be inserted in the pixel island architecture is zero; and
in response to not meeting the second preset quantity relationship, calculating the second number of pixel rows of the dummy pixel rows according to the first number of pixel rows and the clock cycle.

9. The method according to claim 8, wherein determining whether the second preset quantity relationship is met between the first number of pixel rows that the line-of-sight area has and the clock cycle comprises:
determining an activation mode of GOA timing of the line-of-sight area, and determining the first number of pixel rows that the line-of-sight area has and the clock cycle according to the activation mode; wherein the line-of-sight area comprises a human eye gaze area and/or a human eye non-gaze area;
determining whether the second preset quantity relationship is met between the first number of pixel rows and the clock cycle; wherein, in response to the line-of-sight area being the human eye gaze area, the activation mode of the GOA timing comprises a first activation mode or a second activation mode; in response to the line-of-sight area being the human eye non-gaze area, the activation mode of the GOA timing comprises a second activation mode or a third activation mode;
wherein, the first activation mode is GOA row-by-row activation, the second activation mode is GOA two-row concurrent activation, and the third activation mode is GOA four-row concurrent activation.

10. The method according to claim 8, wherein obtaining the first to-be-displayed image by performing the format conversion on the target image data comprises:
obtaining the first to-be-displayed image by performing format conversion on the target image data according to the activation mode of the GOA timing of the line-of-sight area;
wherein, in response to the activation mode being the first activation mode, converting the target image data into the first to-be-displayed image with a first preset data format;
in response to the activation mode being the second activation mode, convert the target image data into the first to-be-displayed image with a second preset data format; and
in response to the activation mode being the third activation mode,
converting the target image data into the first to-be-displayed image with a third preset data format.

11. The method according to claim 4, further comprising:
determining whether a first transistor type of a first thin film field effect transistor comprised in a source driver chip in the display panel is consistent with a second transistor type of a second thin film field effect transistor in the display panel;
in response to the first transistor type and the second transistor type being inconsistent, obtaining a second to-be-displayed image by performing grayscale reverse processing on the first to-be-displayed image.

12. The method according to claim 11, wherein obtaining the second to-be-displayed image by performing grayscale reverse processing on the first to-be-displayed image comprises:
determining whether the source driver chip comprises a floating channel;
in response to determining that the floating channel is comprised, inserting a dummy pixel column into the first to-be-displayed image, and obtaining the second to-be-displayed image by performing grayscale reverse processing on the first to-be-displayed image with the dummy pixel column inserted; wherein, an insertion position of the dummy pixel column in the first to-be-displayed image corresponds to a position of the floating channel in the source driver chip; and
in response to determining that the floating channel is not comprised, obtaining the second to-be-displayed image by performing grayscale reverse processing on the first to-be-displayed image.

13. The method according to claim 12, further comprising:
calculating a number of source driver chips required to drive the display panel according to a number of pixel islands comprised in the display panel, a number of viewpoints of current viewpoints comprised in each pixel island, and a lateral resolution of the display panel;
calculating a total number of channels of the display panel according to a number of chip channels of the source driver chip and the number of source driver chips, and calculating a number of floating channels that need to be inserted in the source driver chip based on the total number of channels and the lateral resolution; and
setting an insertion rule for the floating channels, so that the floating channels are inserted into corresponding source driver chips according to the insertion rule.

14. The method according to claim 13, wherein the insertion rule comprises at least one of the following rules:
each source driver chip with a floating channel inserted is placed in a first preset placement manner;
the floating channel is placed in the source driver chip in a second preset placement manner; and
each source driver chip with a floating channel inserted is placed in a corresponding position of the display panel in a third preset manner.

15. The method according to claim 12, further comprising:
adding an information row to the first to-be-displayed image or the second to-be-displayed image; wherein the information row is configured to represent a position of a high-definition area.

16. (canceled)

17. A computer-readable storage medium on which a computer program is stored, wherein when the computer program is executed by a processor, the following steps are implemented:
obtaining one or more original viewpoint images by a first execution subject, and obtaining a first to-be-displayed image by processing the original viewpoint images;
sending the first to-be-displayed image to a second execution subject by the first execution subject; and
controlling a display panel to display the first to-be-displayed image by the second execution subject.

18. An electronic device, comprising:
a processor; and
a memory for storing executable instructions for the processor;
wherein, when executing the executable instructions, the processor is configured to:
obtain one or more original viewpoint images by a first execution subject, and obtain a first to-be-displayed image by processing the original viewpoint images;
send the first to-be-displayed image to a second execution subject by the first execution subject; and
control a display panel to display the first to-be-displayed image by the second execution subject.
